(19) United States
(12) Patent Application Publication
(10) Pub. No.: US 2025/0061040 A1
(43) Pub. Date: Feb. 20, 2025

(54) Providing Notifications Based on Event Data

(71) Applicant: ServiceNow, Inc., Santa Clara, CA (US)

(72) Inventors: Shravan Kalsanka Pai, Santa Clara, CA (US); Siri Balaji, Santa Clara, CA (US); Prashanti Nilayam, Santa Clara, CA (US); Krishna Kumar Chittepu, Santa Clara, CA (US); Praveen Shekhar, Santa Clara, CA (US); Gaurav Goyal, Santa Clara, CA (US); Sai Krishna Ramineni, Santa Clara, CA (US)

(21) Appl. No.: 18/234,201

(22) Filed: Aug. 15, 2023

(51) Int. Cl. G06F 11/34; H04L 67/30

(52) U.S. Cl. CPC G06F 11/3476; H04L 67/30; G06F 2201/86

(57) ABSTRACT

An example implementation may involve: obtaining state information characterizing a software application, wherein the state information indicates a plurality of use states of the software application; identifying a current use state of the plurality of use states; determining, based on the state information and the current use state, an activity to perform via the software application or a further software application; and providing a message including the activity.

### BACKGROUND

On a large-scale, multi-application computing system, it is possible to track the activities of users as they engage with various software applications. These users, however, may not be aware of the system's full capabilities or the extent of the applications supported. As a result, users may not be able to resolve certain issues even though such resolutions are supported by the system. Furthermore, users may not be aware of uncompleted tasks that they have started but not yet finished.

### SUMMARY

Various implementations disclosed herein include mining application-level and/or system-level event logs to determine intra-application and/or inter-application workflows or patterns of activities that are commonly carried out by users of a computing system. From the resulting data, the system can predict one or more next activities in which users are likely to want or need to engage. With these next activities at hand, the system can prompt the user with a notification (e.g., a reminder or suggestion) to carry out the predicted next activities. Examples of notifications include prompts to use further applications that may be beneficial based on the user's past activities, as well as prompts to complete unfinished tasks. In this fashion, users can rapidly and more efficiently navigate a complex computing platform while reducing the processing and memory resources consumed by unnecessary searches and repetitive queries.

Accordingly, a first example embodiment may involve: obtaining state information characterizing a software application, wherein the state information indicates a plurality of use states of the software application; identifying a current use state of the plurality of use states; determining, based on the state information and the current use state, an activity to perform via the software application or a further software application; and providing a message including the activity.

A second example embodiment may involve a non-transitory computer-readable medium, having stored thereon program instructions that, upon execution by a computing system, cause the computing system to perform operations in accordance with the first example embodiment.

In a third example embodiment, a computing system may include at least one processor, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts an architecture for generating empirical workflows, in accordance with example embodiments.

FIG. 7 depicts an event log, in accordance with example embodiments.

FIGS. 8A, 8B, 8C, and 8D depict graphical user interfaces, in accordance with example embodiments.

FIG. 9 depicts an architecture for generating notifications, in accordance with example embodiments.

FIG. 10 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

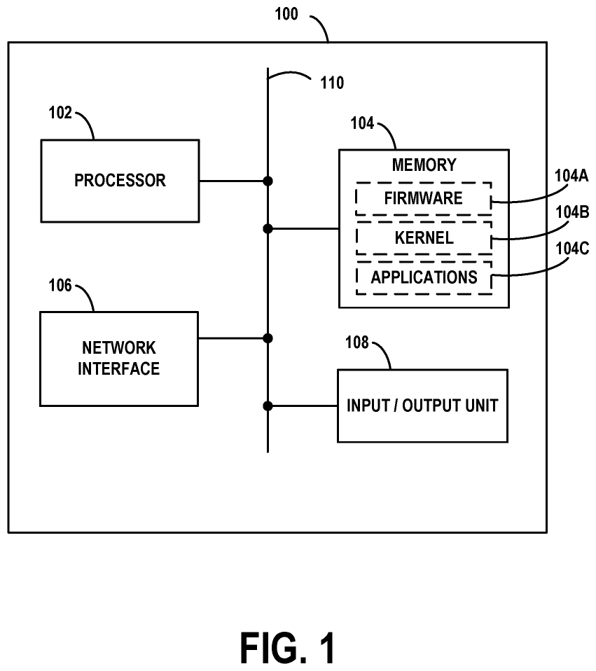

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

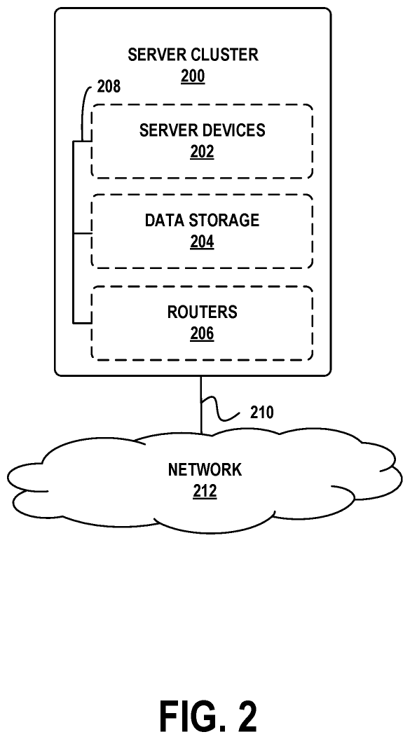

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. EXAMPLE REMOTE NETWORK MANAGEMENT ARCHITECTURE

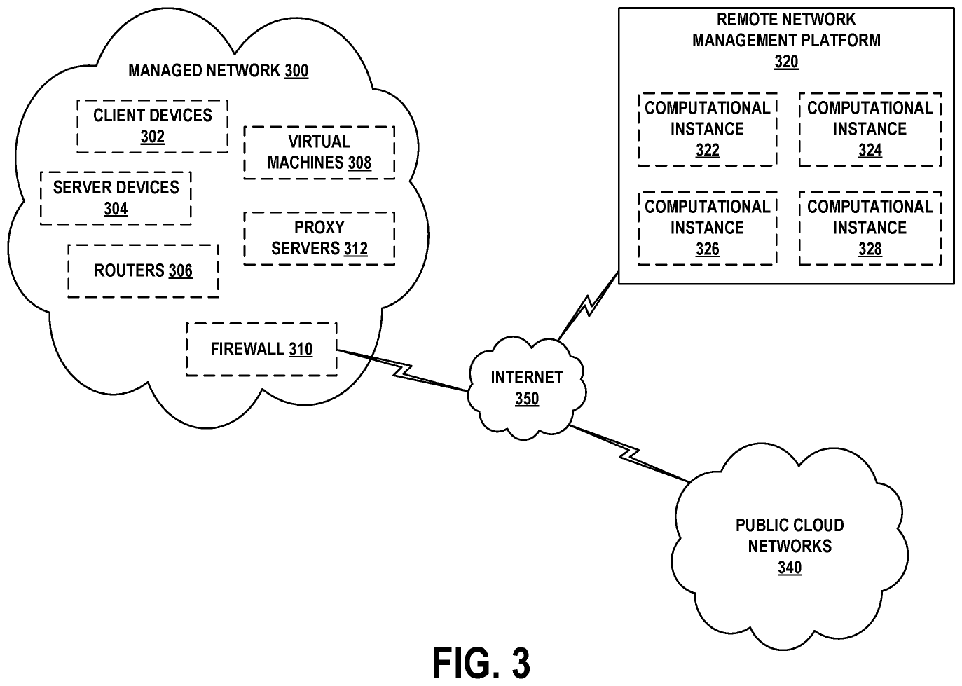

FIG. 3 depicts a remote network management architecture, in accordance with example embodiments. This architecture includes three main components-managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

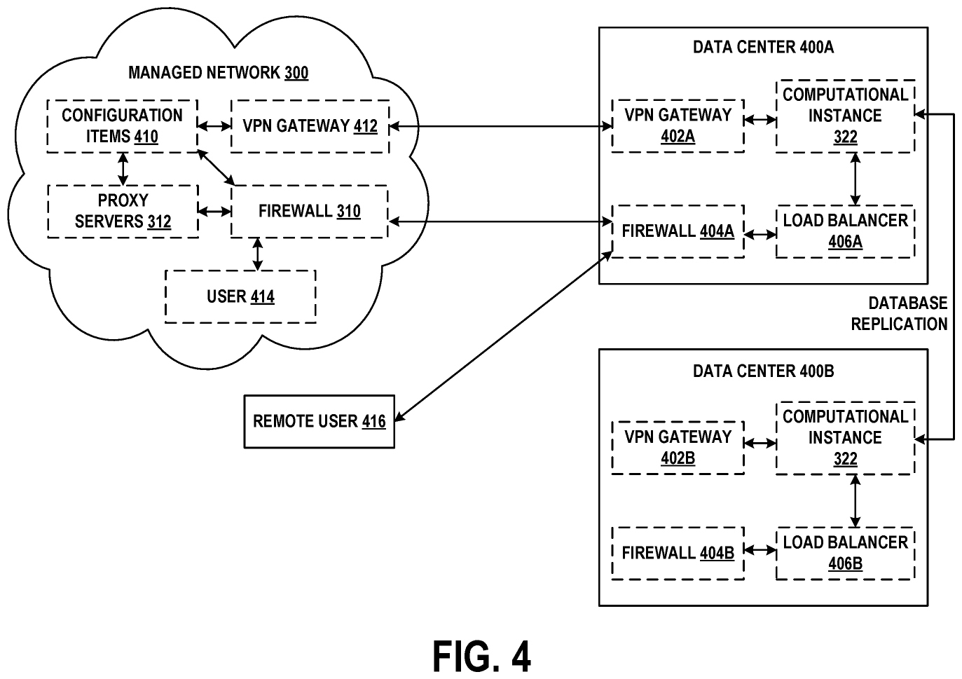

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. EXAMPLE DISCOVERY

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

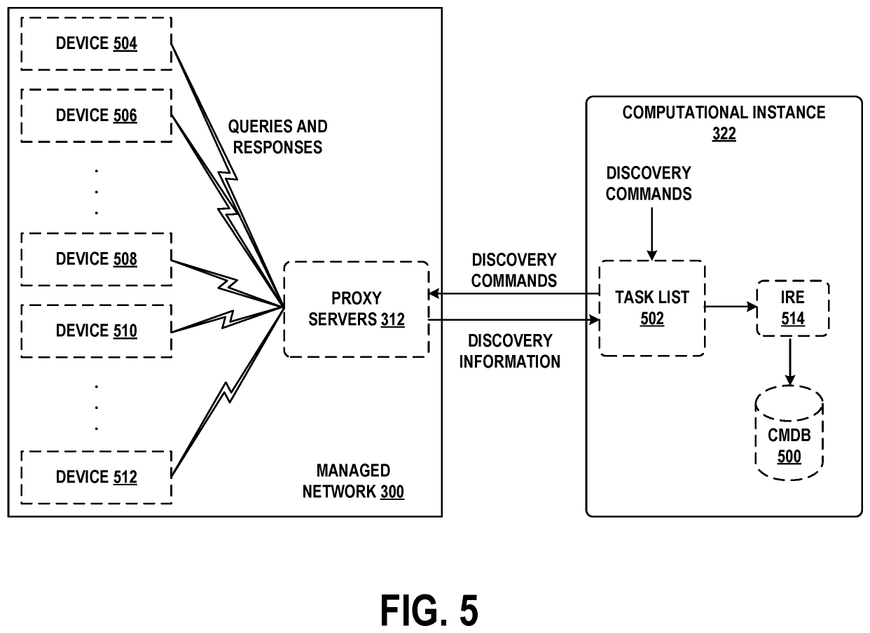

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB IDENTIFICATION RULES AND RECONCILIATION

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. EXAMPLE PLATFORM APPLICATIONS

As noted, remote network management platform 320 may support a number of applications and services, each of which may use or involve information from CMDB 500 and/or other databases as needed. Some of these applications and services may include task-based applications, workflows, user interface building tools, knowledgebases, and agent interfaces, just to name a few. Other applications and services not explicitly discussed herein may benefit from the disclosed embodiments. Nonetheless, these task-based applications, workflows, user interface building tools, knowledgebases, and agent interfaces are briefly described below to provide context for example embodiments.

These applications may be combined with one another in various ways to effectuate the features described herein. For example, a user may be assigned a task to develop a new user interface. This task may be governed by a workflow. The user may employ the user interface building tools to carry out the task, engaging with a virtual agent or knowledgebase along the way for guidance. Other possibilities exist.

### A. Task-Based Applications

Remote network management platform 320 may furnish various IT service management (ITSM) solutions including task-based applications designed to streamline and manage specific processes. Three prominent examples are incident management, case management, and problem management.

Incident management focuses on the efficient resolution of IT service disruptions or incidents. When an issue or disruption occurs, it is logged as an incident in the incident management application. This application allows IT teams to track and manage these incidents throughout their lifecycles. It includes features such as incident creation/generation, assignment, prioritization, escalation, communication, and resolution. The incident management application provides workflows, notifications, and collaboration tools to facilitate the prompt and efficient addressing of incidents, with a goal of minimizing their impact on platform and system operations.

Case management is designed to handle diverse types of processes, requests, or workflows. It enables users to manage complex cases that require coordination across multiple groups. The case management application provides a unified platform to capture, track, and manage cases from initiation to resolution. It includes features such as case creation, classification, assignment, task tracking, collaboration, and closure. This application can be tailored to various use cases, such as HR inquiries, legal matters, facilities management, and customer support escalations among others.

Problem management is drawn to identifying and addressing the root causes of recurring incidents or issues. It helps IT teams identify underlying problems that lead to multiple incidents, analyze their impact, and initiate appropriate actions for resolution. The problem management application provides tools for problem identification, investigation, prioritization, and tracking. It allows users to link related incidents, perform root cause analysis, define workarounds or solutions, and track the progress of problem resolution. The application helps groups minimize the occurrence and impact of recurring issues, leading to improved service quality and stability for the platform and other systems.

### B. Workflows

As noted, task-based applications may employ or be integrated with workflows in some fashion. Here, a workflow defines a sequence of activities and operations used to automate and streamline processes. These workflows may include conditions and branching logic, enabling different paths within the workflow based on specific criteria, such as the values or states of variables or data.

Workflows can be integrated with other applications operable on remote network management platform 320, such as the task-based applications described above. This integration enables cross-application coordination and process synchronization. Further, remote network management platform 320 can integrate workflows with external systems and applications through web services or API calls. This allows for data exchange and collaboration with third-party tools, enabling end-to-end process automation and information sharing.

Remote network management platform 320 may include a workflow designer application that allows users to create, modify, and manage workflows using a drag-and-drop user interface. The application provides a graphical representation of the workflow, making it easier to understand and configure the ordering of activities in the workflow. The application may also provide pre-built workflow templates and libraries that offer ready-to-use workflows for common processes. These templates can be customized to meet specific needs, thus accelerating the implementation of workflows.

### C. User Interface Building Tools

Remote network management platform 320 may provide a user interface builder application that is a visual design tool for creating and customizing user interfaces within the platform. This application may employ a low-code/no-code approach to designing intuitive graphical user interfaces, enabling administrators and developers to build user interface components without extensive coding knowledge.

Notably, low-code/no-code design refers to a development approach that enables the creation of software applications with minimal or no coding required. It involves using visual interfaces, drag-and-drop components, and declarative configuration instead of writing traditional lines of code.

Low-code platforms can provide a visual development environment that allows users to design and build applications through graphical interfaces, pre-built components, and configuration options. They typically offer a set of functionalities and connectors to integrate with external systems, databases, and services. No-code platforms take the concept of low-code a step further by enabling users with little to no programming experience to create applications. These platforms offer a highly visual and intuitive interface where users can build applications using simple drag-and-drop actions, visual workflows, and configuration options. No-code platforms often provide a library of pre-built templates, modules, and integrations, allowing users to assemble and customize applications without writing any code.

Both low-code and no-code approaches aim to simplify and streamline the software development process, making it accessible to a broader range of users, including business analysts, citizen developers, and subject matter experts. These approaches can empower non-technical users to create functional and scalable applications, reduce the reliance on traditional coding, and accelerate the development lifecycle.

To that point, the user interface builder application may include a drag-and-drop interface that simplifies the process of creating user interfaces. Users can add and arrange user interface components such as fields, buttons, containers, tables, and images onto the canvas, eliminating the need for manual coding. In doing so, the application may rely on a library of pre-built user interface components that users can choose from, including form fields, widgets, buttons, and navigation elements. These components can be added to the canvas and customized according to specific needs.

These user interface components may be bound to data sources within remote network management platform 320. This enables dynamic data display, real-time updates, and synchronization between the user interface and underlying data. The application also allows integration with other applications and workflows, as well as the use of conditional logic (e.g., visibility rules, triggering of actions, etc.) to create interactive and context-aware user interfaces.

### D. Knowledgebases

A knowledgebase can include one or more databases of information that centralize and manage an organization's knowledge resources. Example features of a knowledgebase include: content in the form of articles, search functionality, access control, feedback, integration with task-based applications, and analytics.

Knowledge articles are a core component of a knowledgebase. These documents can be created, modified, and organized by authorized users within the organization. They act as a repository of knowledge, capturing information on various topics, including troubleshooting guides, FAQs, how-to guides, and best practices. The knowledgebase may support versioning, allowing multiple revisions of an article to be stored. This helps maintain a history of changes, updates, and improvements made to an article over time.

A knowledgebase may offer robust search capabilities to quickly find relevant articles. Users may be able to use keywords, tags, or categories to locate the information they need. The knowledgebase may also be able to restrict access based on user roles and permissions. This helps ensure that sensitive or confidential information is only accessible to authorized personnel. Users may have the option to provide feedback on articles, indicating whether the article was helpful or to what extent the article was or was not helpful. This feedback helps in identifying areas for improvement and maintaining the quality of the knowledge repository.

A knowledgebase can be tightly integrated with task-based applications. In the case of incident management, for example, the system can suggest relevant knowledge articles that might help in resolving incidents. This case reduce or eliminate the need for human intervention.

The platform may record article usage (e.g., view and feedback) and provide reporting and analytics features to track their usage and effectiveness. This allows administrators to monitor article popularity and usefulness, search trends, and user satisfaction.

### E. Virtual Agents

Remote network management platform 320 may also support virtual agents. These can be artificial-intelligence powered conversational interfaces designed to interact with users and provide automated assistance. Virtual agents can be integrated into various interfaces and applications, such as web portals, chat interfaces, and messaging platforms to offer self-service options and enhance the user experience. The virtual agents operable on remote network management platform 320 may be different from the virtual agent features of a large language model (LLM). Notably, platform virtual agents may employ LLMs in some situations, but can also operate based on local platform content and pre-defined dialog trees, for example.

Virtual agents can engage in dynamic and context-rich conversations with users. They can guide users through predefined conversation flows, prompt for information, ask clarifying questions, and provide relevant responses or recommendations based on the user's needs. These virtual agents can be integrated with a knowledgebase. Virtual agents can access this knowledgebase to retrieve relevant information and provide self-help resources to users. Virtual agents can also automate common tasks or processes within the platform. They can initiate workflows, create tasks, perform system actions, or provide status updates, allowing users to complete tasks without manual intervention.

Further, virtual agents can transfer conversations to live (human) agents when necessary or desirable. If a virtual agent cannot resolve a user's query or if the user requests human assistance, the conversation can be handed off to a live agent for further support and resolution. Such a handoff may involve providing, to the live agent, the context (and possibly some or all of the content) of the conversation between the user and the virtual agent.

### VII. GENERATING WORKFLOWS FROM EVENTS

Any of the above platform applications, or other applications not explicitly discussed herein, may be employed as part of a larger framework to detect a predicted next activity in which a user may want to engage. The framework may then notify the user about this next activity (e.g., in the form of a reminder or suggestion). In some cases, the user may be aware of the next activity and may have forgotten to carry it out. In other cases, due to the complexity of the platform's multi-application nature, the user may not even know that the next activity is a possible option.

Each application may record a rich set of events into dedicated or shared event logs. Events include records of when a user logs into the computing system, navigates to a page, fills out a field or selects an user interface option from a form, a database entry is created, modified, or deleted, and so on. Events may be used for analytics, telemetry, and/or other purposes.

As events trace a user's activity path across one or more applications, event logs may be mined to determine common or expected next activities. As an example, a user may access a knowledgebase article and the computing system of the platform may record this access as an event. Perhaps hours or days later, the computing system may send a notification to the user asking if the user wishes to continue reading the article and maybe suggest other related articles by way of links.

In some cases, the article may describe how the user can engage in a workflow (e.g., to request new IT equipment or time off from work), and the notification may include a link to initiate such a workflow. In other cases, the user may be logging in to the computing system from a different client device (e.g., the user initially read the article on a mobile phone and now is logging in from a desktop computer) and this detected change of client device may cause the computing system to send such a notification.

In yet further cases, if the computing system determines that the user is spending more than a threshold amount of time reading the article or keeps returning to the article over time, the computing system may provide a link for the user to engage in a chat session or phone call with a virtual or human agent for assistance. The computing system may automatically provide the virtual or human agent with the topic of the article for context and perhaps a copy of the article. In some cases, an intra-application or inter-application timeline of relevant events may be provided to the virtual or human agent, also for context.

Other possibilities exist. For example, the user may partially fill out a form (e.g., for a new incident or to set up an appointment) and after a pre-determined period of time the computing system may notify the user with a reminder to complete the form. Or, a user may engage in searches for particular information and the system may prompt the user to respond indicating whether their search was successful and perhaps suggest resources that the user can view that are related to the topic of the search.

In another example, an agent or administrator may routinely (e.g., once a day or once a week) perform a task (e.g., filling out a form or checking the status of a user interface). The computing system may identify the periodic pattern in this behavior and then suggest to the agent or administrator that the computing system proactively remind them to perform the task or suggest an automation tool that can help them perform the task.

The implementations described herein facilitate these functionalities as well as numerous other functionality examples. The computing systems described herein provide a full-stack platform framework to create single application or multi-application customer experiences that facilitate engagement continuity as users switch between applications and interactions, while retaining relevant information contextualized to each application and/or interaction. This provides users with an integrated experience as they use one or more applications, with contextually relevant assistance, real time content sharing, and personalized experiences. Doing so increases the utility of the computing system while reducing the computing resources (processing power and memory) that it utilizes when users engage in repetitive or unnecessary activities.

### A. Empirical Workflow Generation

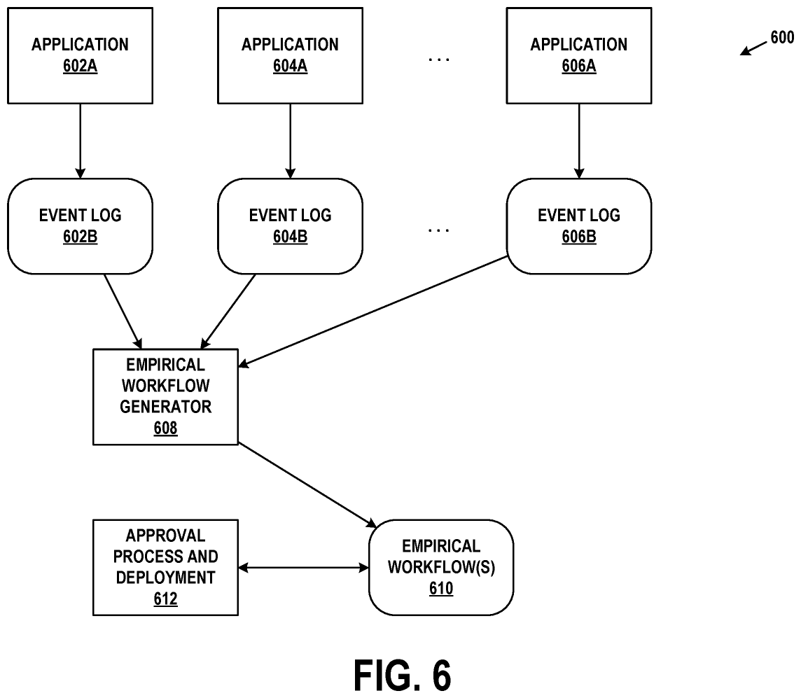

FIG. 6 depicts example architecture 600 for generating empirical workflows from event logs. This architecture may take the form of a combination of software applications that populate event logs and generate empirical workflows from the events. In FIG. 6, objects with square corners generally refer to executable programs, while objects with rounded corners generally refer to data.

Here, the empirical workflows may be developed “bottom up” from patterns of events across one or more applications rather than pure “top down” design from an administrator (alternatively, workflow design may originate from an expert in how applications are intended to be used on the computing system). This has the advantage of identifying workflows that are too complex or unintuitive for human administrators to infer, while also being inherently adaptable to changing and emergent patterns of application usage. Nonetheless, empirical workflows may be reviewed, modified, and approved by human administrators, and may incorporate some aspects of top-down design.

Herein, the term “empirical workflow” indicates a workflow that is at least partially generated from events in event logs. This term may be used synonymously with the term “state machine”. Also, the term “notification” may be used synonymously with the term “message”.

In FIG. 6, applications 602A, 604A, and 606A are three of potentially many applications (as indicated by the ellipsis) provided by a computing system. Each application may be one of the example applications described above (e.g., a task-based application, a workflow application, a user interface builder, a knowledgebase application, or a virtual agent application) or some other type of application.

Event logs 602B, 604B, and 606B are logging mechanisms respectively dedicated to applications 602A, 604A, and 606A (i.e., event log 602B receives and records events from application 602A, event log 604B receives and records events from application 604A, and so on). Like applications 602A, 604A, and 606A, there may be potentially many event logs (as indicated by the ellipsis). In some cases, more than one application may provide events to the same event log. Thus the mappings of applications to event logs can be one-to-one or many-to-one.

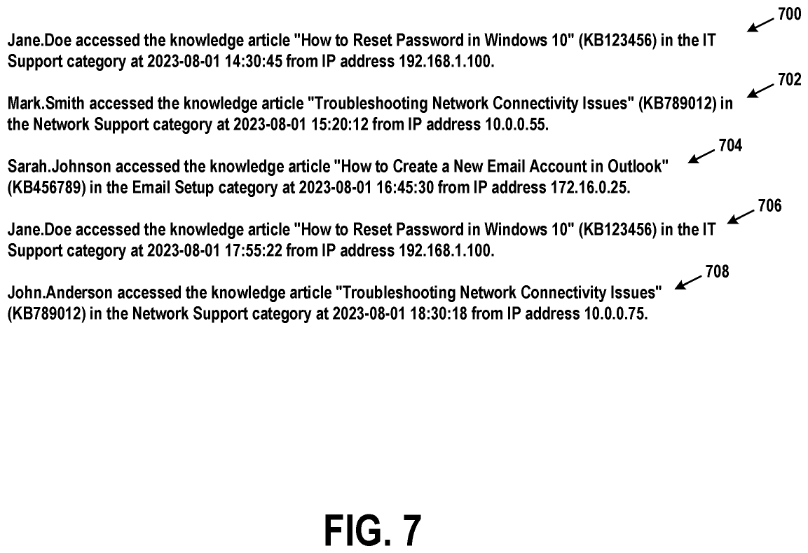

Each of event logs 602B, 604B, and 606B may represent events in a similar or different textual format. Further, events may be stored in flat text files, structured text files (e.g., JSON or XML), or as entries in a database as examples. For instance, and turning momentarily to FIG. 7, events 700, 702, 704, 706, and 708 may appear in an event log that receives events from a knowledgebase application. Each event indicates that an article has been accessed (e.g., downloaded to a browsers and possibly read), and specifies the user, the title of the article, the article number (e.g., KB123456), the article's category, the time of the access, and the network address (e.g., IP address) of the client device used to access the article. More or less information may be supplied in these events. For example, URLs of the articles may appear in the events as well.

Notably, user Jane Doe accessed article KB123456 twice, which may be an indication that this user is struggling with password reset issues and may benefit from additional suggestions or assistance. Also, two users have accessed article KB789012, which may be an indication that this article is popular and/or helpful.

Turning back to FIG. 6, empirical workflow generator 608 may read from event logs 602B, 604B, and 606B and generate empirical workflow(s) 610. In doing so, empirical workflow generator 608 may carry out a multistep process. A goal of this process is to produce a probabilistic state machine based on the events.

For instance, empirical workflow generator 608 may initially load the events into a suitable data structure (e.g., a list, array, or database table). In some cases, empirical workflow generator 608 may sort the events into chronological order.

Then, empirical workflow generator 608 may identify or infer states from the events. This may involve examining the events to ascertain specific actions, conditions, or statuses, for example. In some cases, empirical workflow generator 608 may group similar events into the same state, define start and end states of the workflow, remove noisy events that are repetitive or not related to a state or transition, and so on.

Then, empirical workflow generator 608 may define state transition rules from these states. This may involve analyzing the states to find patterns or conditions that indicate a transition from one state to another. These could be explicit events, specific types of events, or changes in the log data that signal state transitions. In some cases, certain events or data may indicate the entry into or exit from a particular state.

For example, suppose that event A for an application indicates that the user's interaction with the application is in state A′, event B for the application indicates that the user's interaction with the application is in state B′, and event C for the application indicates that the user's interaction with the application is in state C′. If the event log indicates that event B follows event A 80% of the time and event C follows event A 20% of the time, empirical workflow generator 608 may define state transition rules indicating that state A′ leads to state B′ with 80% probability, and that state A′ leads to state C′ with 20% probability.

In some cases, empirical workflow generator 608 may determine expected state durations for each state. Doing so may involve calculating the duration or time spent in each state (e.g., from the time when occupancy of a state begins and when it ends based on the timestamps of the relevant events).

### B. Empirical Workflow Modification and Approval

Regardless of how they are developed, empirical workflows(s) 610 may be subject to approval and deployment 612. This process may present empirical workflows(s) 610 to a human administrator for modification and/or approval. Once approved, empirical workflows(s) 610 may be deployed for production use.

This editing and/or approval may involve the human administrator modifying or confirming the state machine (e.g., the states and transition rules) of the workflow, and the event logs or database tables used progress through the empirical workflow. The event logs or database tables may contain incoming events as well as static data related to the user's role and/or demographics. Any or all of this information may be used to determine whether a notification is to be sent and the content of that notification, as well as how the notification should be delivered.

In some cases, an empirical workflow can be configured so that notifications may be sent when the user's progress through the empirical workflow “stalls” in a given state for more than a predefined period of time. This predefined period of time may be different for each state, and may be based on the expected state durations for each state, as described above. For example, the predefined period of time for a state may be the mean duration in each state plus one or two standard deviations, as determined from event logs.

Moreover, whether a notification is transmitted can be based on the user's recorded activity within a predefined lookback period (e.g., 5 minutes, 1 hour, 1 day, etc.). Thus, the user's progression through a workflow may be evaluated within this lookback period and notifications may be provided (or not provided) accordingly.

Further, whether the notification is transmitted to the user and the content of the notification may be configurable based on the user and/or the user's role. Some users may choose to subscribe to such notifications (in which case the computing system will provide the notifications to the user) or unsubscribe from such notifications (in which case the computing system will not provide the notifications to the user). Also, the role of the user may determine which notifications are provided to that user. A regular user of an application may receive a different set of notifications than an agent, administrator, or VIP user and/or these notifications may contain different content per role.

User demographics may also influence notifications in a similar manner. For example, a user located in one jurisdiction (e.g., the U.S.) might have a different set of operational requirements and constraints than a user located in a different jurisdiction (e.g., India).

Additionally, past usage behavior of a user may also be used to influence whether and which notifications are provided and/or the content thereof. For example, a user might have a history of following a certain path through their usage of one or more applications, and the user might be prompted to continue following this path even if the majority of event log data suggests that another path is more common.

In some cases, notification delivery mechanisms may also be configured by an administrator. Notifications can be delivered to a user in various ways, e.g., email, text message, virtual agent, web interface, by invoking an application, and so on.

Ultimately, an empirical workflow may be considered a state machine with transition rules that govern movement between its states. Each state may be associated with notification rules that determine when a notification is provided and the content of that notification. Each notification may be governed by delivery rules that determine how a notification is provided.

### C. Graphical User Interfaces for Notification Definition

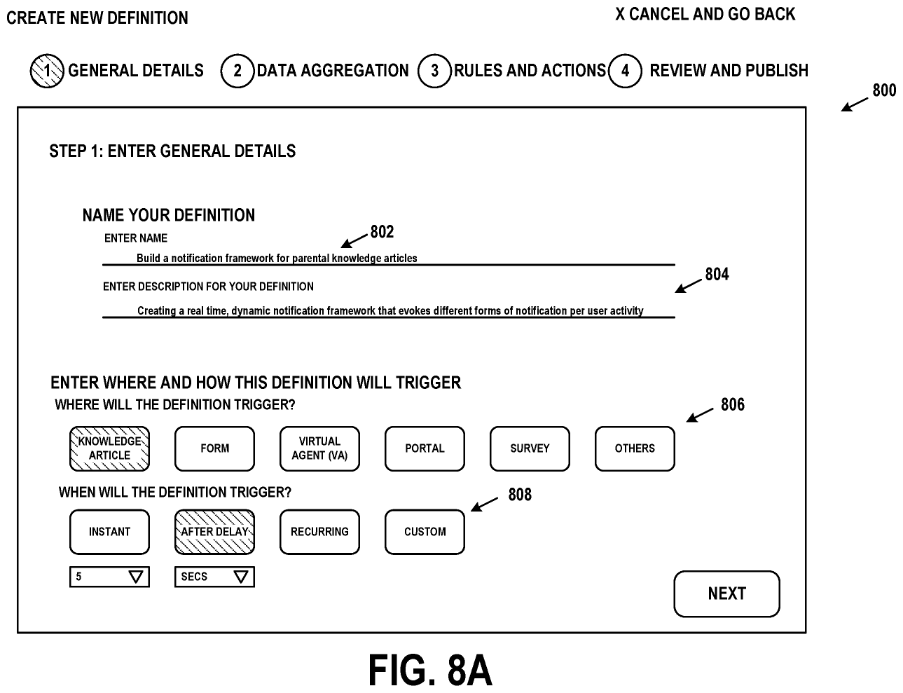

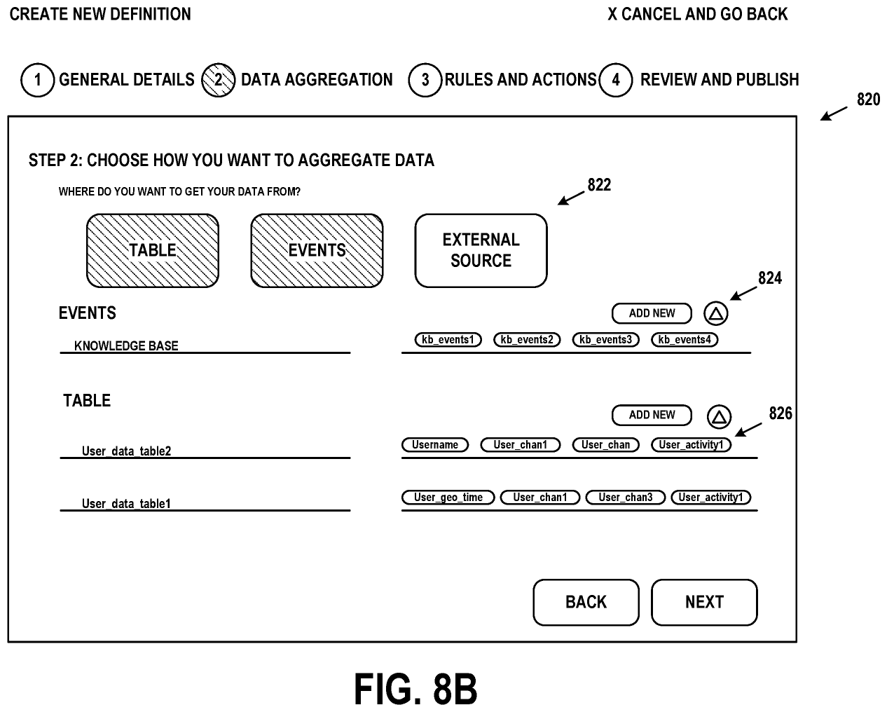

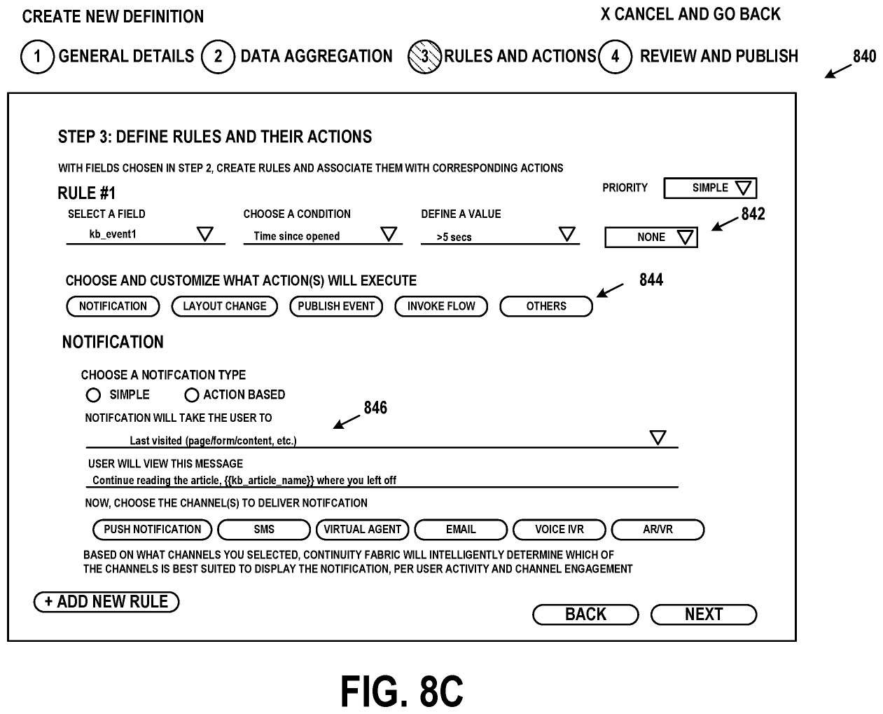

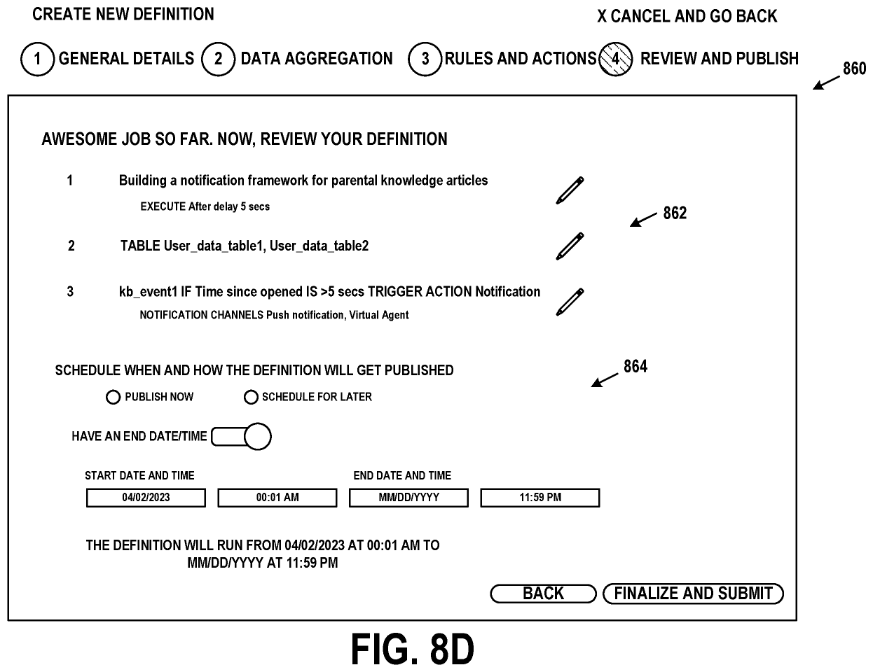

FIGS. 8A-8D depict graphical user interfaces that further illustrate how an administrator might develop or modify a workflow. In particular, FIGS. 8A-8D demonstrate how a notification can be defined in a guided fashion. Nonetheless, these graphical user interfaces are provided for purposes of example and other sequences of screens, displayed content, and/or selectable options may be possible. However, for sake of simplicity, they do not explicitly encompass all of the features described here.

While these graphical user interfaces do not explicitly link a notification to an empirical workflow, they do implicitly allow such a linking. For example, linking the notification to the state and/or content of events in an event log or database table may effectively link the notification to a workflow as described herein.

Graphical user interface 800 of FIG. 8A prompts the administrator to provide general details relating to a notification. This includes the notification's name 802, description 804, triggering source 806, and triggering time 808. Notably, triggering source 806 allows the administrator to select between a knowledgebase article, a form, a virtual agent, a portal, a survey, and other sources. Each of these sources may be associated with a different application. Triggering time 808 allows the administrator to specify that the notification is transmitted immediately, after a configurable delay period, on a recurring basis, or in some other fashion.

Graphical user interface 820 of FIG. 8B follows graphical user interface 800 and prompts the administrator to specify data sources used to trigger the notification and/or for use in a message generated as part of the notification. This includes selector 822 allowing the administrator to choose one or more data sources. As shown, the table and events options of selector 822 have been chosen. Thus, events menu 824 prompts the administrator to select one or more fields of events from an event log. Also, table menu 826 prompts the administrator to specify one or more database tables as well as one or more fields from each. As noted, the content of these fields may be used by rules to determine whether and when a notification is provided as well as content of the notification.

Graphical user interface 840 of FIG. 8C follows graphical user interface 820 and prompts the administrator to define rule(s) and their associated action(s). Sub-interface 842 allows the administrator to define a first rule (Rule #1). As an example, Rule #1 is based on the value of the Kb_event1 field and is triggered when the associated article has been opened for more than 5 seconds. Action selector 844 allows the administrator to specify the action for this rule. As shown, it is a notification. Notification menu 846 allows the administrator to define the notification. Here, the notification is simple rather than action based and will provide a link to take the user to the last visited article and display a corresponding message. Notification menu 846 allows the administrator to specify the channel through which to deliver the notification, such as a push, a text message (SMS), virtual agent, email, interactive voice response (IVR), or augmented reality/virtual reality (AR/VR).

Graphical user interface 860 of FIG. 8D follows graphical user interface 840 and prompts the administrator to review the defined notification and determine when and how the notification will be published (activated). Menu 862 displays the definition of the notification and allows the administrator to edit this definition. Menu 864 allows the administrator to activate the notification through publication or schedule the publication to a future time frame.

### VIII. EXECUTING DEPLOYED WORKFLOWS

A deployed workflow may execute in the background (e.g., the workflow application is executing but does not require active user interaction or a visible interface on a screen) while a user is otherwise interacting with the computing platform. For example, referring once more to FIG. 6, a notification generator (not shown) may receive incoming events from event logs 602B, 604B, and 606B as the user is engaged with applications 602A, 604A, and 606A. The notification generator may use these events, or a subset thereof, to determine the state(s) at which the user is in of empirical workflows(s) 610 and also evaluate rules governing whether and when notifications should be sent to the user. Notably, these rules can be defined in the same or a similar fashion as described in the context of FIG. 8A-8D.

Given a particular empirical workflow, the notification generator may begin the workflow in its start state. As the notification generator receives events, the notification generator may update the state of the workflow accordingly. For instance, the events may indicate that the workflow has transitioned from the start state to a second state, and then from the second state to a third state. Once in the third state, the notification generator might, for a predefined period of time, receive no further events or only events that do not cause any further transitions in the empirical workflow.

After the predefined period of time has passed with the empirical workflow in the third state, the notification generator may generate and send a notification to the user. The notification may suggest that the user engage in an action that would cause the empirical workflow to transition to a fourth state, where the fourth state is a most likely or likely transition from the third state. In some cases, the third state may have transitions to a number of other states. The notification may include a number of suggestions related to several or all of these states, thereby providing the user with options with the understanding that at least one of these options may be relevant to the user's needs.

A goal of this notification is to prompt the user to re-engage with the application or applications driving the empirical workflow so that the empirical workflow can complete. Thus, such notifications may be provided to the user in accordance with the transitions and various predefined periods of time until the empirical workflow has entered its end state.

Continuing with an example, suppose that a user accesses a knowledgebase article regarding how to reset their password. An empirical workflow may exist that maintains the user in an intermediate state with respect to this article until the user performs a password reset procedure. If the notification generator determines that the user has been in this intermediate state for more than the predefined period of time associated with the intermediate state, the notification generator may transmit a notification to the user that prompts the user either (i) perform the password reset procedure, (ii) re-access the knowledgebase article, or (iii) engage with a virtual or human agent for help. Other possibilities exist.

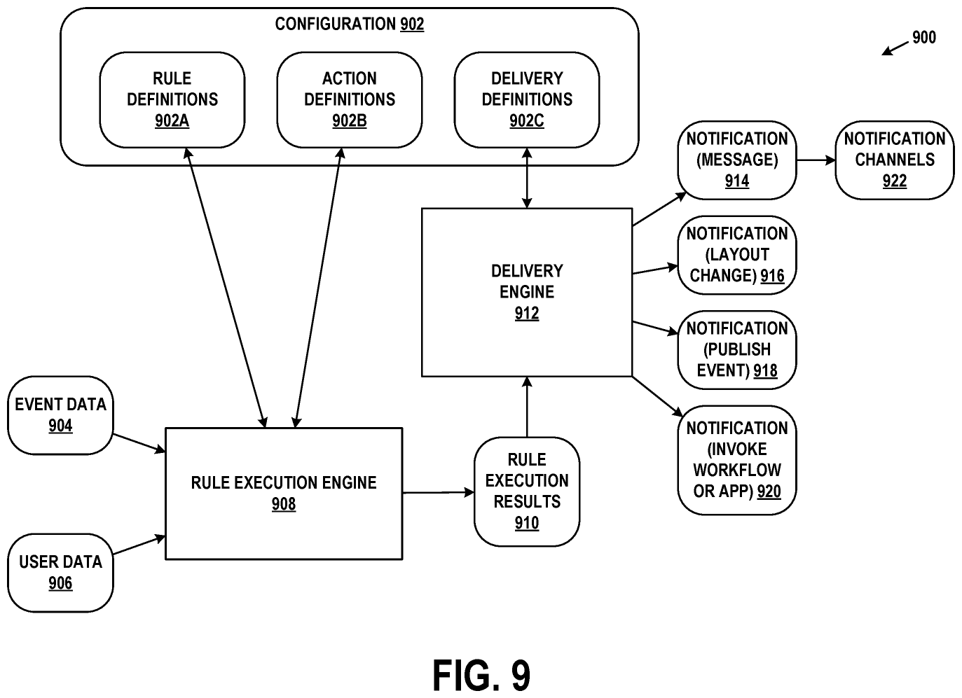

FIG. 9 depicts software architecture 900 for applying rule-based notifications. This architecture is provided for purposes of example, and the embodiments herein may employ the same or similar architectures. In FIG. 9, objects with square corners generally refer to executable programs, while objects with rounded corners generally refer to data.

Configuration 902 includes rule definitions 902A, action definitions 902B, and delivery definitions 902C. Rule definitions 902A include rules that were defined by an administrator that govern whether and when notifications are provided. Action definitions 902B determine what type of notification is provided. Delivery definitions 902C specify how a notification is to be provided and possibly via which channel.

Rule execution engine 908 receives event data 904 (e.g., from event logs and/or database tables) and user data 906. Generally, user data 906 is static and provided just once per use of rule execution engine 908 (though it could be provided more than once), while event data 904 may be streamed in real time to rule execution engine 908 or provided statically. Rule execution engine 908 applies rule definitions 902A to event data 904 and user data 906, and determines when the criteria for a rule is met (i.e., the rule is triggered). When this is the case, rule execution engine 908 applies action definitions to determine the type of notification based on a combination of one or more of the triggered rule, event data 904, or user data 906.

Rule execution engine 908 produces rule execution results 910. Rule execution results 910 may include, for example, an indication of the type of notification to be provided as well as any further data to be incorporated in to the notification.

Delivery engine 912 receives rule execution results 910 and applies delivery definitions 902C to these results. The outcome is generation of a notification, which may be message 914, layout change 916 (e.g., to a user interface), event publication 918 (e.g., posting the event to a message queue, database, log, or user interface), or invocation of a further workflow or application 920. This notification is then transmitted by way of an appropriate channel. In some cases, the type of notification may have several possible channels, and delivery definitions 902C may define which one should be used (e.g., push, text message, email, virtual agent, IVR, and so on).

### IX. EXAMPLE TECHNICAL IMPROVEMENTS

These embodiments provide a technical solution to a technical problem. One technical problem being solved is determining when a user has interacted with one or more applications to something other than a point of completion. In practice, this is problematic because uncompleted application interactions take up memory and will remain in memory perpetually unless they are specifically examined.

In the prior art, there was no solution with respect to determining when a user has not completed such an interaction with applications, much less how to prompt the user to complete the interaction. To the extent that per-application or cross-application workflows to address these goals even exist, these workflows were designed in a top-down fashion, imposing the subjective experiences of an administrator or designer on the user. This would lead to wildly varying workflows depending on the administrator or designer.

The embodiments herein overcome these limitations by automatically generating workflows from event logs. In this manner, workflow generation can be accomplished in a more accurate and robust fashion. This results in several advantages. First, the workflows are based on common user activity within or between applications. Second, the workflows can easily be modified as usage patterns change. Third, uncompleted application interactions can be detected by way of these workflows and users can be prompted to complete such activities (or indicate that they are not interested in such completion). Therefore, memory usage can be reduced and made more efficient.

Other technical improvements may also flow from these embodiments, and other technical problems may be solved. Thus, this statement of technical improvements is not limiting and instead constitutes examples of advantages that can be realized from the embodiments.

### X. EXAMPLE OPERATIONS

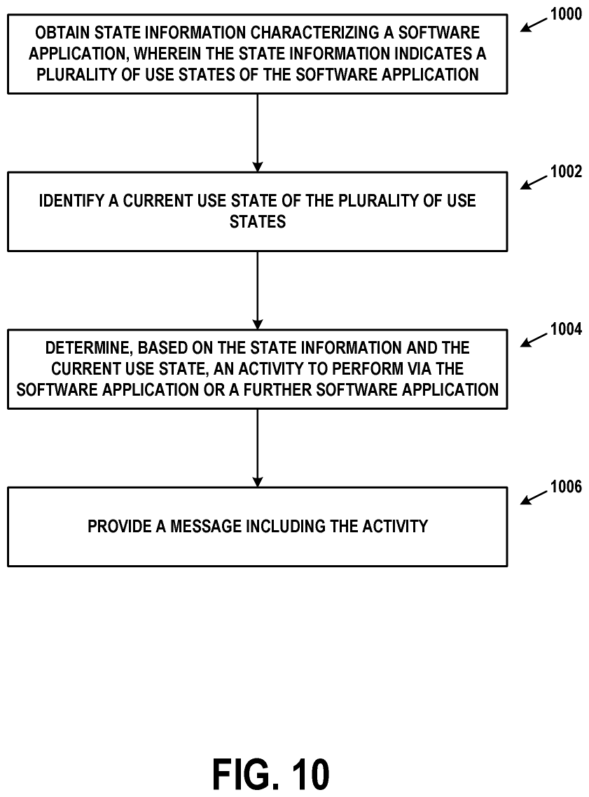

FIG. 10 is a flow chart illustrating an example embodiment. The process illustrated by FIG. 10 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 10 may be simplified by the removal of any one or more of the features shown therein. Further, these embodiments may be combined with features, aspects, and/or implementations of any of the previous figures or otherwise described herein.

Block 1000 may involve obtaining state information characterizing a software application, wherein the state information indicates a plurality of use states of the software application.

Block 1002 may involve identifying a current use state of the plurality of use states.

Block 1004 may involve determining, based on the state information and the current use state, an activity to perform via the software application or a further software application.

Block 1006 may involve providing a message including the activity.

In some examples, a user of the software application is in the current use state of the software application.

In some examples, determining the activity to perform is also based profile information related to the user.

In some examples, identifying the current use state of the plurality of use states comprises: receiving a feed of events from an event log associated with the software application; and determining the current use state based on at least some of the events.

In some examples, the plurality of use states of the software application were generated based on an event log of previous events generated by the software application.

In some examples, the plurality of use states of the software application are part of an empirical workflow, wherein the use states and transitions therebetween characterize patterns of previous usage of the software application.

In some examples, determining the activity to perform comprises determining that at least a predefined amount of time has passed since the current use state was entered.

In some examples, determining the activity to perform is also based on use states of the plurality of use states that were occupied during a predefined lookback period of time.

In some examples, determining the activity to perform comprises: determining that a first client device was used to bring the software application into the current use state; and determining that the software application has been accessed from a second client device.

In some examples, an aspect of the software application is in an incomplete condition, and wherein the activity is to continue using the software application from the incomplete condition.

In some examples, the current use state indicates that use of the software application has been unable to resolve a condition, and wherein the activity is to use the further software application to resolve the condition.

In some examples, the state information includes one or more criteria under which the message is to be provided, and wherein determining the activity to perform comprises determining that the one or more criteria are met.

In some examples, the state information includes a channel through which the message is to be provided, and wherein providing the message comprises providing the message via the channel.

In some examples, providing the message comprises providing the message as a notification, via a layout change to a user interface, via an event, or by invoking an application or workflow.

In some examples, identifying the current use state of the plurality of use states comprises obtaining event data from an event log or database table, and wherein determining the activity to perform comprises applying rule definitions to the event data to determine the activity to perform.

### XI. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
obtaining state information characterizing a software application, wherein the state information indicates a plurality of use states of the software application;
identifying a current use state of the plurality of use states;
determining, based on the state information and the current use state, an activity to perform via the software application or a further software application; and
providing a message including the activity.

2. The method of claim 1, wherein a user of the software application is in the current use state of the software application.

3. The method of claim 2, wherein determining the activity to perform is also based profile information related to the user.

4. The method of claim 1, wherein identifying the current use state of the plurality of use states comprises:
receiving a feed of events from an event log associated with the software application; and
determining the current use state based on at least some of the events.

5. The method of claim 1, wherein the plurality of use states of the software application were generated based on an event log of previous events generated by the software application.

6. The method of claim 1, wherein the plurality of use states of the software application are part of an empirical workflow, wherein the use states and transitions therebetween characterize patterns of previous usage of the software application.

7. The method of claim 1, wherein determining the activity to perform comprises determining that at least a predefined amount of time has passed since the current use state was entered.

8. The method of claim 1, wherein determining the activity to perform is also based on use states of the plurality of use states that were occupied during a predefined lookback period of time.

9. The method of claim 1, wherein determining the activity to perform comprises:
determining that a first client device was used to bring the software application into the current use state; and
determining that the software application has been accessed from a second client device.

10. The method of claim 1, wherein an aspect of the software application is in an incomplete condition, and wherein the activity is to continue using the software application from the incomplete condition.

11. The method of claim 1, wherein the current use state indicates that use of the software application has been unable to resolve a condition, and wherein the activity is to use the further software application to resolve the condition.

12. The method of claim 1, wherein the state information includes one or more criteria under which the message is to be provided, and wherein determining the activity to perform comprises determining that the one or more criteria are met.

13. The method of claim 1, wherein the state information includes a channel through which the message is to be provided, and wherein providing the message comprises providing the message via the channel.

14. The method of claim 1, wherein providing the message comprises providing the message as a notification, via a layout change to a user interface, via an event, or by invoking an application or workflow.

15. The method of claim 1, wherein identifying the current use state of the plurality of use states comprises obtaining event data from an event log or database table, and wherein determining the activity to perform comprises applying rule definitions to the event data to determine the activity to perform.

16. A non-transitory computer-readable medium, having stored thereon program instructions that, upon execution by a computing system, cause the computing system to perform operations comprising:
obtaining state information characterizing a software application, wherein the state information indicates a plurality of use states of the software application;
identifying a current use state of the plurality of use states;
determining, based on the state information and the current use state, an activity to perform via the software application or a further software application; and
providing a message including the activity.

17. The non-transitory computer-readable medium of claim 16, wherein identifying the current use state of the plurality of use states comprises:
receiving a feed of events from an event log associated with the software application; and
determining the current use state based on at least some of the events.

18. The non-transitory computer-readable medium of claim 16, wherein the plurality of use states of the software application are part of an empirical workflow, wherein the use states and transitions therebetween characterize patterns of previous usage of the software application.

19. The non-transitory computer-readable medium of claim 16, wherein determining the activity to perform comprises:
determining that a first client device was used to bring the software application into the current use state; and
determining that the software application has been accessed from a second client device

20. A system comprising:
one or more processors; and
memory, containing program instructions that, upon execution by the one or more processors, cause the system to perform operations comprising:
obtaining state information characterizing a software application, wherein the state information indicates a plurality of use states of the software application;
identifying a current use state of the plurality of use states;
determining, based on the state information and the current use state, an activity to perform via the software application or a further software application; and
providing a message including the activity.
